(19) United States
(12) Patent Application Publication
(10) Pub. No.: US 2017/0013455 A1
(43) Pub. Date: Jan. 12, 2017

(54) Communication device having an identifier

(71) Applicant: AvocadoNinja BV, Amsterdam (NL)

(72) Inventor: Aike MÜLLER, Amsterdam (NL)

(73) Assignee: AvocadoNinja BV

(21) Appl. No.: 15/197,771

(22) Filed: Jun. 30, 2016

Related U.S. Application Data
(60) Provisional application No. 62/189,807, filed on Jul. 8, 2015.

(51) Int. Cl. H04W 12/06; G06F 1/24; H04W 8/22

(52) U.S. Cl. CPC H04W 12/06; H04W 8/22; G06F 1/24

(57) ABSTRACT

A device for communicating over a network, comprising a radio subsystem for acquiring a network identifier from a signal representative of a wireless network and an identifier subsystem for assigning the device an identifier derived from said acquired network identifier. The identifier subsystem is preferably configured to use the acquired network identifier as one of plural inputs to a cryptographic function whose output is the assigned identifier.

### FIELD OF THE INVENTION

The invention relates to a device for communicating over a network and to a computer-readable storage medium.

### BACKGROUND OF THE INVENTION

More and more devices are being designed to connect to networks such as the Internet. In general, this requires that the device has some form of identifying number, allowing it to be distinguished from other devices. A popular form of identifying number is the media access control address or MAC address, which is a unique identifier assigned to network interfaces used in many internet-enabled devices.

Many of these identifiers are fixed, e.g. because they are encoded in read-only memory. This has a serious disadvantage from a privacy perspective: one could collect and combine information about the user with this identifier. Further, if the device is returned or sold to another owner, the identifier would falsely be correlated with activities of the previous owner.

As a result, interest has arisen in dynamically generated identifiers. A device then generates an identifier when it is first being put into use and/or when it is given a “factory reset”. This identifier is generated from various sources of data, e.g. a processor identifier combined with a networking chip identifier and the operating speed of the device. However, it is well known that these sources are less than ideal. It is hard to generate a truly random identifier on devices with identical hardware and software as boot times and processor speed are identical.

Pseudo-random number generators (PRNGs) may also be used to obtain numbers that appear random. Unfortunately, there is insufficient entropy to generate unique identifier using PRNGs, as these tools too have to use sources like the ones mentioned above. This increases the chance that their output is more predictable than desired. A better solution is a hardware random number generator, which is a device which generates random numbers from a physical process. These are often based on phenomena such as the photoelectric effect or other quantum phenomena. Some modern CPUs now have true random number generators built on the die. However, this is not the case for cost efficient embedded chipsets.

### SUMMARY OF THE INVENTION

The invention provides an improvement on the above in that it comprises a radio subsystem for acquiring a network identifier from a signal representative of a wireless network and an identifier subsystem for assigning the device an identifier derived from said acquired network identifier. The network identifier preferably is the Service Set Identifier as defined in the IEEE 802.11 family of standards. Network identifiers vary greatly from location to location and from time to time. This therefore provides an advantageous input to use in creating a random identifier. Of course the device may acquire and use multiple network identifiers in the derivation. In fact the more identifiers are obtained, the more random the identifier will be.

The invention is of particular interest in the area of virtual private network (VPN) services, where it is often desirable to allow the user of such a network to stay anonymous as much as possible. When assigning a unique identifier using the method of the invention, even the provider of the VPN service will have a hard time tracking or recognizing this user.

In an embodiment the identifier subsystem is configured to use the acquired network identifier as one of plural inputs to a cryptographic function whose output is the assigned identifier. A cryptographic function such as the well-known SHA-256 hash function is well suited to turn plural inputs into one (alpha-)numeric code that may serve as an identifier. Other inputs may a strength of the signal in the deriving and a measurement of a voltage level of a battery present in the device.

In a further embodiment the device comprises factory reset means to reset all device settings to an initial state, said means being configured to erase the assigned identifier and to cause the identifier subsystem to repeat its operation. It is advantageous to allow the device identifier to be erased and re-calculated, for example when the device is being sold second hand.

The invention further provides for a computer-readable storage medium comprising executable code for causing a computer to operate as the system of the invention.

### BRIEF DESCRIPTION OF THE FIGURES

The invention will now be explained in more detail with reference to the figures, in which:

FIG. 1 schematically shows an arrangement with a device according to the invention, a network such as the Internet and various other devices configured for communicating over the network with remote systems such as server using the device;

FIG. 2 schematically shows the device in more detail; and

FIG. 3 shows a flowchart illustrating the steps taken by the device in accordance with the invention.

In the figures, same reference numbers indicate same or similar features. In cases where plural identical features, objects or items are shown, reference numerals are provided only for a representative sample so as to not affect clarity of the figures.

### DETAILED DESCRIPTION OF CERTAIN EMBODIMENTS

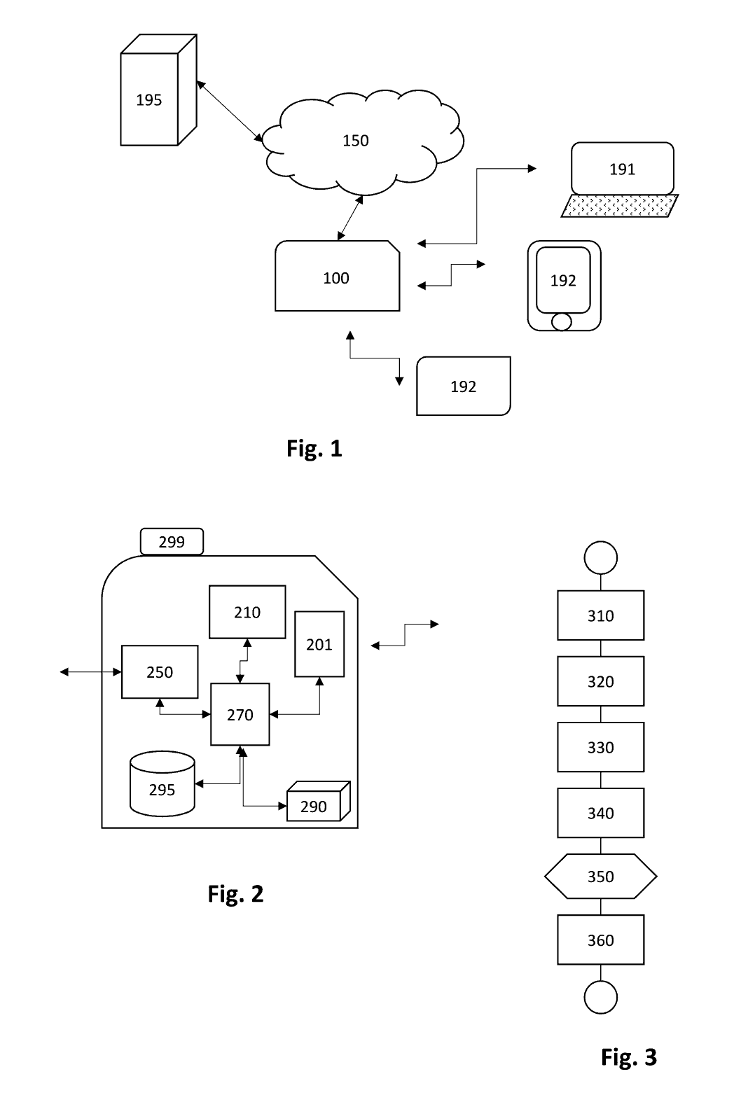

FIG. 1 schematically shows an arrangement with a device 100 according to the invention, a network 150 such as the Internet and various other devices 191, 192, 193 configured for communicating over the network 150 with remote systems such as server 195 using the device 100. The other devices 191, 192, 193 are shown here as a laptop, a tablet computer and a mobile phone but can be any device that can be so configured.

The device 100 provides for bridging and routing capabilities to enable the other devices 191, 192, 193 to communicate over the network. In the embodiment shown, the other devices 191, 192, 193 send communications to the device 100 over a wireless connection, which passes the communications on to the network 150 for reception by e.g. the remote server 195. Responses from this server 195 are received by the device 100 and in turn passed on back to the intended device of devices 191, 192, 193. As such, this capability of devices like device 100 is known in the art. The device 100 may comprise virtual private networking (VPN) capabilities, where traffic is encrypted and routed through a different network.

In one embodiment, the device 100 is used as follows. A user connects her laptop and/or phone to connect it to the private, encrypted Wifi network offered by the device 100. Using this network, she connects to the open, unencrypted Wifi of a restaurant or hotel. She accesses the website of a content provider such as Netflix to enjoy the content. Traffic is routed through a VPN server before reaching the content provider. For this provider, traffic is originating from the VPN server. The device 100 receives updates and updated configuration from a configuration server (not shown). All connections are encrypted on a high level.

FIG. 2 schematically shows the device 100 in more detail. The device 100 comprises a radio subsystem 201 configured for communicating wirelessly with the devices 191, 192, 193. Preferably the IEEE 802.11 family of standards is used for such communication. Other wireless standards, e.g. the Bluetooth family of standards, or even wired communication, e.g. using an Ethernet connection, are also possible. In addition, the device 100 comprises a networking subsystem 250 configured for communicating over the network 150 with remote systems such as server 195. As shown in FIG. 2, the networking subsystem 250 comprises a wired communication system using Ethernet to connect to the network 150, but alternatively a wireless communication system such as 3G or 4G wireless mobile Internet or any other option for connecting to networks such as the Internet may also be used.

The device 100 further comprises an identifier subsystem 210 whose working is described below, a processing unit 270 to execute computer instructions that cause the device to operate as described, an internal memory 295, preferably a Flash memory, for storing the computer instructions and a battery 290 to power the device. Other elements, such as a USB host subsystem may be added as desired.

The device 100 may further comprise a factory reset module 299, e.g. embodied as a button on top of the device 100 as shown in FIG. 2, to reset all device settings to an initial state. Preferably, this module 299 is configured to erase the assigned identifier and to cause the device to repeat the process of FIG. 3.

FIG. 3 shows a flowchart illustrating the steps taken by device 100 in accordance with the invention. The device 100 at one or more points in time needs to be assigned an identifier. This may occur during first startup, during startup after a complete power-down, at the user's request or during a factory reset. Optionally, the device 100 can be equipped with resetting means (not shown) that initiate the process of FIG. 3.

When an identifier is to be assigned, the process of FIG. 3 is initiated. At step 310, one or more network identifiers are gathered. This step is initiated by identifier subsystem 210, which is configured for assigning the device an identifier derived from said acquired network identifier. The subsystem 210 activates the radio subsystem 201, which is configured for acquiring one or more network identifiers from one or more signals representative of a wireless network. Preferably this network identifier is from the IEEE 802.11 family of standards, but other standards may also be used.

In one embodiment, the radio subsystem 201 uses a different type of network identifier for this acquisition than for the wireless communication with devices 191, 192, 193. For example, if the devices use 802.11 wireless communication, the subsystem 201 gathers Bluetooth identifiers, or vice versa.

In steps 320, 330, 340 one or more further inputs are gathered. These steps are optional and may be performed in any order, even prior to step 310. In step 320, a measurement of a voltage level of battery 290 is taken as a further input. In step 330, strength(s) of the one or more acquired signals of step 310 are taken as further input. In step 340 a current date and time are gathered as a further input. Yet further inputs may be thought of and gathered at this point.

In step 350, a cryptographic function is applied to all the inputs gathered, including the network identifiers and the strengths of the signals, if acquired. In an embodiment, the cryptographic function is a strong hash function such as SHA-256. The inputs must typically be combined into one input string or input number for such functions, various options exist for this requirement. In a first embodiment, all the inputs are concatenated into one large string, which is then converted into a number which is fed as an input to the cryptographic function.

The output of the function is then used in step 360 to assign as identifier for the device 100. If the output of the function is of different length than the required length for an identifier, the output must be adjusted first. If the output is too long, one or more elements may be dropped. If the output is too short, then the function could be applied twice or more to different inputs, concatenating the outputs to assign as identifier.

The above provides a description of several useful embodiments that serve to illustrate and describe the invention. The description is not intended to be an exhaustive description of all possible ways in which the invention can be implemented or used. The skilled person will be able to think of many modifications and variations that still rely on the essential features of the invention as presented in the claims. In addition, well-known methods, procedures, components, and circuits have not been described in detail.

Some or all aspects of the invention may be implemented in a computer program product, i.e. a collection of computer program instructions stored on a computer readable storage device for execution by a computer. The instructions of the present invention may be in any interpretable or executable code mechanism, including but not limited to scripts, interpretable programs, dynamic link libraries (DLLs) or Java classes. The instructions can be provided as complete executable programs, as modifications to existing programs or extensions (“plugins”) for existing programs. Moreover, parts of the processing of the present invention may be distributed over multiple computers or processors for better performance, reliability, and/or cost.

Storage devices suitable for storing computer program instructions include all forms of non-volatile memory, including by way of example semiconductor memory devices, such as EPROM, EEPROM, and flash memory devices, magnetic disks such as the internal and external hard disk drives and removable disks, magneto-optical disks and CD-ROM disks. The computer program product can be distributed on such a storage device, or may be offered for download through HTTP, FTP or similar mechanism using a server connected to a network such as the Internet. Transmission of the computer program product by e-mail is of course also possible.

When constructing or interpreting the claims, any mention of reference signs shall not be regarded as a limitation of the claimed feature to the referenced feature or embodiment. The use of the word “comprising” in the claims does not exclude the presence of other features than claimed in a system, product or method implementing the invention. Any reference to a claim feature in the singular shall not exclude the presence of a plurality of this feature. The word “means” in a claim can refer to a single means or to plural means for providing the indicated function.

1. A device for communicating over a network, comprising a radio subsystem for acquiring a network identifier from a signal representative of a wireless network and an identifier subsystem for assigning the device an identifier derived from said acquired network identifier.

2. The device of claim 1, where the network identifier is the Service Set Identifier as defined in the IEEE 802.11 family of standards.

3. The device of claim 1, in which the identifier subsystem is configured to use the acquired network identifier as one of plural inputs to a cryptographic function whose output is the assigned identifier.

4. The device of claim 3, in which the identifier subsystem is configured to use a strength of the signal as another of said plural inputs.

5. The device of claim 3, further comprising a battery to power the device, the identifier subsystem being configured to use a measurement of a voltage level of said battery as another of said plural inputs.

6. The device of claim 3, further comprising factory reset means to reset all device settings to an initial state, said means being configured to erase the assigned identifier and to cause the identifier subsystem to repeat its operation.

7. A computer-readable storage medium comprising executable code for causing a computer to operate as the device of claim 1.
